(19) United States
(12) Patent Application Publication
(10) Pub. No.: US 2019/0121290 A1
(43) Pub. Date: Apr. 25, 2019

(54) DIGITAL HOLOGRAPHIC IMAGING APPARATUS

(71) Applicant: OLYMPUS CORPORATION, Tokyo (JP)

(72) Inventor: Toshiro OKAMURA, Tokyo (JP)

(73) Assignee: OLYMPUS CORPORATION, Tokyo (JP)

(21) Appl. No.: 16/224,530

(22) Filed: Dec. 18, 2018

Related U.S. Application Data
(63) Continuation of application No. PCT/JP2016/068425, filed on Jun. 21, 2016.

(51) Int. Cl. G03H 1/04; G03H 1/08

(52) U.S. Cl. CPC G03H 1/0443; G03H 2001/005; G03H 1/0406; G03H 1/0866

(57) ABSTRACT

An illumination unit emits illumination light to a specimen held by a sample holder, which includes an AF mark that changes at least the amplitude or phase of part of the illumination light. An image sensor includes multiple pixels two-dimensionally arranged on an imaging surface, captures an image of the intensity distribution of an interference pattern formed on the imaging surface, and outputs captured image data. An AF operation unit generates a first intensity distribution representing a measurement value of the interference pattern corresponding to the AF mark based on the captured image data, generates a second intensity distribution representing a calculation value of an interference pattern corresponding to the AF mark by calculation, and executes an autofocus operation wherein the first intensity distribution approaches the second. A reconstruction calculation unit reconstructs a subject image representing the specimen based on the captured image data.

### BACKGROUND OF THE INVENTION

### 1. Field of the Invention

The present invention relates to a digital holographic imaging apparatus.

### 2. Description of the Related Art

A lens-free digital holographic imaging apparatus is employed in order to capture an image of phase information or intensity information with respect to a cell sample. The digital holographic imaging apparatus emits illumination light to a specimen, measures a generated interference pattern by means of an image sensor, and reconstructs the phase distribution information or intensity distribution information by calculation based on the interference pattern. Related techniques are disclosed in Patent document 1 (Japanese Patent No. 4,772,961) and non-patent document 1 (“Autofocusing and edge detection schemes in cell volume measurements with quantitative phase microscopy”, OPTICS EXPRESS, 13 Apr. 2009, Vol. 1, No. 8, p. 6476).

Such a digital holographic imaging apparatus uses the distance (optical path length) Z between a specimen and an image sensor in reconstruction calculation. In a case in which an optional optical element is inserted, such an arrangement requires a high-precision distance conversion giving consideration to the effect of the optical element (which will be referred to as the “distance” hereafter). If the distance Z is not acquired with high precision, this arrangement is not able to reconstruct (reproduce) a correct subject image. Accordingly, before the reconstruction calculation, this arrangement requires an autofocus (AF) operation.

In the autofocus operation of a camera, a focusing lens is moved in a direction in which the contrast of the captured image becomes larger. Furthermore, the position of the focusing lens is acquired such that the contrast becomes its maximum. In a case of a digital holographic imaging apparatus, the distance Z, which is to be used in diffraction calculation (propagation calculation) for reconstructing the amplitude and the phase of the specimen based on the holographic image thus captured, may preferably be changed so as to determine the distance Z at which the amplitude image of the specimen thus reconstructed exhibits its maximum contrast. Also, the relative distance between the specimen and the image sensor may be changed while the distance Z to be used in the diffraction calculation is fixed. The patent document discloses a technique relating to this arrangement.

As a result of investigating the techniques disclosed in Patent documents 1 and 2, the present inventor has come to recognize the following problem.

In a case in which the specimen is a phase object such as cells or the like, the reconstructed amplitude image of the specimen lacks contrast. Accordingly, the distance Z to be used in the diffraction calculation cannot be calculated based on the amplitude image. In order to solve such a problem, a method is conceivable in which the distance Z is calculated using the contrast of the reconstructed phase image of the specimen. However, in a case in which the specimen is a phase object, a phase image having large contrast is not necessarily a correct phase image.

FIG. 1 is a diagram for explaining the contrast of a phase image. A specimen 100 such as cells or the like can be regarded as a phase object. It can be assumed that the specimen 100 has a lens function. In a case in which the phase image of the specimen 100 is reconstructed from a holographic image captured by the image sensor 102, when the diffraction calculation is performed with a distance value that is smaller than the correct distance Z_{OBJ}, this leads to an increase in the contrast of the phase image. If the diffraction calculation is performed with a larger value, the wave fronts become closer to those of plane waves, thereby reducing the contrast of the phase image. In some cases, this relation is reversed depending on the phase distribution of the specimen.

That is to say, the relation between the distance Z used in the calculation and the contrast depends on the specimen 100. Accordingly, it is difficult to employ the contrast of the phase image as an AF index. It should be noted that description has been made with reference to FIG. 1 regarding an example in which the specimen is a transparent phase object. Also, the same can be said of a case in which the specimen 100 is a reflective phase object as described in Patent document 1.

In the technique described in Non-patent document 1, the SGA (Squared Gradient Algorithm) index or otherwise the LFA (Laplacian Filtering Algorithm) index respectively represented by the following Expressions is employed instead of employing the contrast of the reconstructed phase image of the specimen as the autofocus index.

SGA≡∫∫[(∂f(x,y)/∂x)²+(∂f(x,y)/∂y)²]dxdy

LFA≡∫∫[(∂²f(x,y)/∂x²)+(∂²f(x,y)/∂y²)]²dxdy (Expression 1)

Here, “f(x, y)” represents the reconstructed phase image of the specimen. “x” and “y” represent a coordinate position on a sample surface.

The index such as the SGA or LFA using differential values described in Non-patent document 1 makes use of the fact that the reconstruction of a specimen with a correct distance provides a reconstructed image with high smoothness, and that, in many cases, the reconstruction thereof with an incorrect distance leads to a reconstructed image having large roughness. In a case in which the phase distribution of the specimen has high spatial frequency components, the above-described tendency appears clearly. However, in a case in which the phase distribution of the specimen has no such high spatial frequency components, this tendency does not appear clearly. Furthermore, the change in the index is small at a distance in the vicinity of the correct distance. In this case, the distance Z to be used in the high-precision diffraction calculation cannot be acquired. That is to say, the precision of the autofocus operation depends on the phase distribution of the specimen. Accordingly, in some cases, the autofocus operation cannot be performed depending on the specimen.

### SUMMARY OF THE INVENTION

The present invention has been made in view of such a situation. Accordingly, it is an exemplary purpose of an embodiment of the present invention to provide an autofocus technique that is not dependent on a specimen.

An embodiment of the present invention relates to a digital holographic imagining apparatus. The digital holographic imaging apparatus comprises: an illumination unit structured to emit an illumination light to a specimen; a sample holder structured to hold the specimen, and to have an AF mark structured to change at least one from among an amplitude and a phase of a part of the illumination light; an image sensor comprising multiple pixels arranged in a two-dimensional manner on an imaging surface, and structured to capture an image of an intensity distribution of an interference pattern formed on the imaging surface, and to output captured image data; an autofocus operation unit structured to generate, based on the captured image data, a first intensity distribution that represents a measurement value of an interference pattern that corresponds to the AF mark, to calculate a second intensity distribution that represents a calculated value of the interference pattern that corresponds to the AF mark, and to execute an autofocus operation such that the first intensity distribution approaches the second intensity distribution; and a reconstruction calculation unit structured to reconstruct a subject image that represents the subject based on the captured image data. The autofocus operation unit and the reconstruction calculation unit may be implemented with one or more processor.

It should be noted that the “autofocus operation” used in the present specification refers to an operation such that the actual distance between the specimen and the image sensor matches the distance used in the reconstruction calculation. Examples of the autofocus operation include: an operation in which the distance used in the reconstruction calculation is changed while the actual distance between them is fixed; an operation in which the actual distance is changed while the distance used in the reconstruction calculation is fixed; and a combination of the above-described operations.

Another embodiment of the present invention relates to a sample holder employed in a digital holographic imaging apparatus, and structured to hold a specimen. The sample holder comprises an AF mark arranged on a sample surface thereof that is to be in contact with the specimen. The AF mark is structured to change at least one from among an amplitude and a phase of a part of an illumination light.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram for explaining the contrast of a phase image;

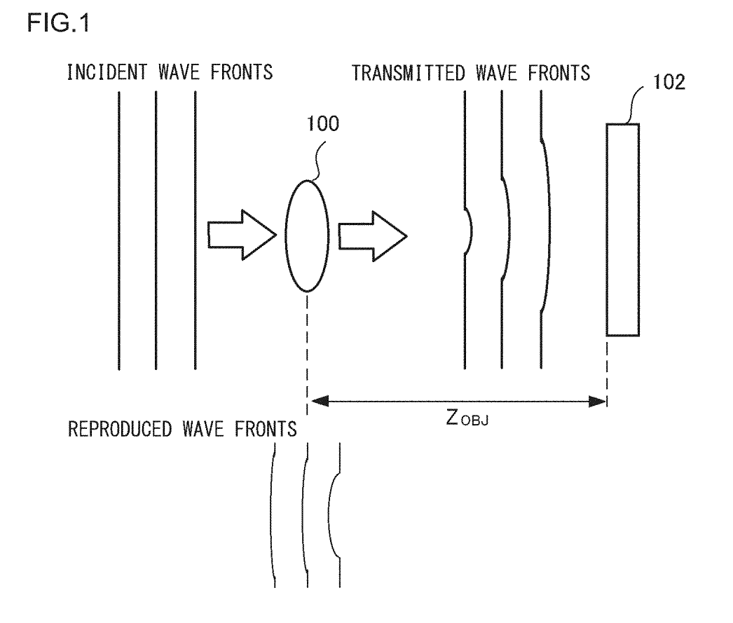

FIG. 2 is a basic configuration of a digital holographic imaging apparatus according to an embodiment;

FIG. 3 is a diagram for explaining the principle of the digital holographic imaging apparatus;

FIG. 4 is a diagram for explaining an autofocus operation of the digital holographic imaging apparatus;

FIG. 5 is a cross-sectional diagram showing a sample holder according to a first embodiment;

FIGS. 6A and 6B are diagrams for explaining an AF mark according to the first embodiment;

FIG. 7A is a diagram showing a phase distribution ϕ_{OBJ}(x, y) of a specimen, FIG. 7B is a diagram showing the position relation between the specimen and the AF mark, and FIG. 7C is a diagram showing the light intensity distribution I(x, y) formed on an imaging surface due to the specimen and the AF mark;

FIG. 8 is a flowchart showing the autofocus operation according to the first embodiment;

FIG. 9 is a flowchart showing reconstruction calculation for an image of a specimen according to a first embodiment;

FIG. 10 is a cross-sectional diagram showing a sample holder according to the second embodiment;

FIGS. 11A and 11B are diagrams for explaining the AF mark according to the second embodiment;

FIG. 12 is a diagram showing a light intensity distribution I(x, y) formed on the imaging surface due to the specimen and the AF mark;

FIG. 13 is a flowchart showing the reconstruction calculation for an image of the specimen according to the second embodiment;

FIGS. 14A through 14E are diagrams for explaining the AF mark according to a third embodiment;

FIG. 15 is a flowchart showing a design method for the AF mark that provides a phase distribution.

FIGS. 16A through 16D are diagrams for explaining another example of the AF mark.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

### Overview

First, an overview is made regarding several embodiments according to the present invention.

An embodiment of the present invention relates to a digital holographic imaging apparatus. The digital holographic imaging apparatus comprises: an illumination unit structured to emit an illumination light to a specimen; a sample holder structured to hold the specimen, and to have an AF mark structured to change at least one from among an amplitude and a phase of a part of the illumination light; an image sensor comprising multiple pixels arranged in a two-dimensional manner on an imaging surface, and structured to capture an image of an intensity distribution of an interference pattern formed on the imaging surface, and to output captured image data; an autofocus operation unit structured to generate, based on the captured image data, a first intensity distribution that represents a measurement value of an interference pattern that corresponds to the AF mark, to calculate a second intensity distribution that represents a calculated value of the interference pattern that corresponds to the AF mark, and to execute an autofocus operation such that the first intensity distribution approaches the second intensity distribution; and a reconstruction calculation unit structured to reconstruct a subject image that represents the subject based on the captured image data.

The AF mark is a known subject. Accordingly, in a case in which a given propagation distance z is assumed, the second intensity distribution formed on the imaging surface due to the AF mark can be calculated. By making a comparison between the second intensity distribution thus calculated and the first intensity distribution measured in actuality, this arrangement is capable of providing the autofocus operation without depending on the specimen. Furthermore, in the autofocus operation, there is no need to reproduce the image of the specimen every time the propagation distance z is changed. Accordingly, this arrangement allows the time required for the autofocus operation to be reduced.

Also, the AF mark may be formed on a sample surface of the sample holder that is to be in contact with the specimen.

Also, the AF mark may be structured to change only a phase of the illumination light. This arrangement requires only the thickness of the sample holder to be changed, thereby providing an advantage of allowing the AF mark to be manufactured in a simple manner. In addition, in a case in which the specimen is a phase object, this arrangement requires only a simple calculation.

Also, the AF mark may be structured to change only an amplitude of the illumination light.

Also, the AF mark may be designed to form an interference pattern on the imaging surface such that it is positioned outside of a region that receives a zero-order light emitted from the specimen. This arrangement is capable of reducing the effects of the specimen in the autofocus operation. This provides the autofocus operation with improved precision.

Also, the spatial frequency band of the interference pattern that corresponds to the AF mark may be limited such that the spatial resolution of the AF mark is larger than a processing limit value for the AF mark.

Also, the autofocus operation unit may change a distance used in calculation of the second intensity distribution while a distance between the sample holder and the imaging surface is fixed.

Also, the autofocus operation unit may repeat: calculating the second intensity distribution such that the AF mark propagates at a distance z; calculating an index that represents a difference or otherwise a similarity between the first intensity distribution and the second intensity distribution; and changing the distance z so as to minimize or otherwise maximize the index.

Also, the index may be the sum of squares of differences between the first intensity distribution and the second intensity distribution for each pixel.

Also, the autofocus operation unit may change a distance between the sample holder and the imaging surface while a distance used in calculation of the second intensity distribution is fixed.

Another embodiment of the present invention relates to a sample holder employed in a digital holographic imaging apparatus, and structured to hold a specimen. The sample holder comprises an AF mark arranged on a sample surface thereof that is to be in contact with the specimen. The AF mark is structured to change at least one from among an amplitude and a phase of a part of an illumination light.

### EMBODIMENTS

Description will be made below regarding the present invention based on preferred embodiments with reference to the drawings. The same or similar components, members, and processes are denoted by the same reference numerals, and redundant description thereof will be omitted as appropriate. The embodiments have been described for exemplary purposes only, and are by no means intended to restrict the present invention. Also, it is not necessarily essential for the present invention that all the features or a combination thereof be provided as described in the embodiments.

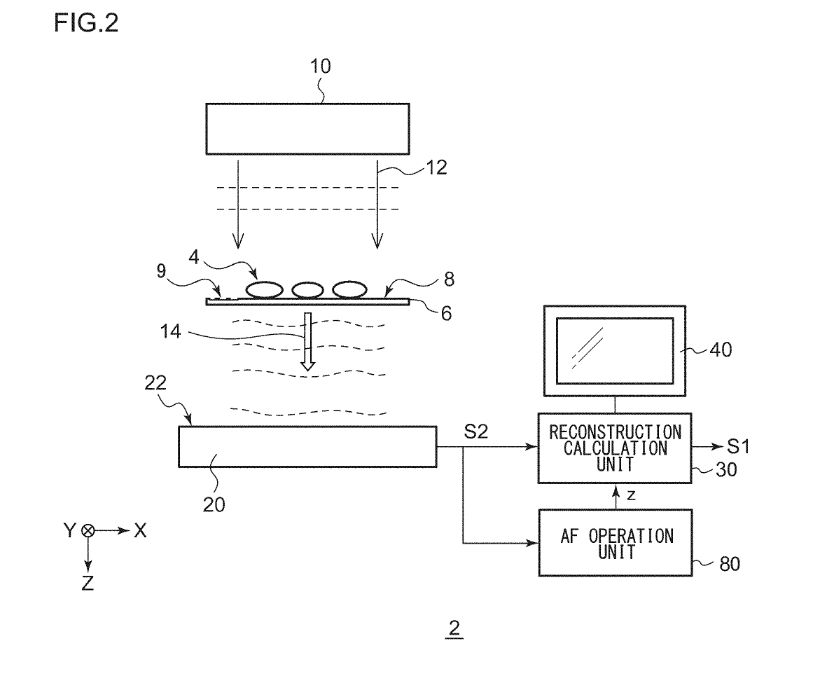

FIG. 2 is a diagram showing a basic configuration of a digital holographic imaging apparatus 2 according to an embodiment. In some cases, the sizes (thickness, length, width, and the like) of each component shown in the drawings are expanded or reduced as appropriate for ease of understanding. The size relation between multiple components in the drawings does not necessarily match the actual size relation between them. That is to say, even in a case in which a given member A has a thickness (length) that is larger than that of another member B in the drawings, in some cases, in actuality, the member A has a thickness (length) that is smaller than that of the member B.

The digital holographic imaging apparatus 2 can be used to observe a phase object, an amplitude object, and an object having both characteristics. That is to say, the observation target is not restricted in particular. Description will be made in the present embodiment regarding an example in which a phase object such as cells is employed as an observation target (specimen 4). The specimen 4 is held at a predetermined position by means of a sample holder 6. The plane on which the specimen 4 is positioned will be referred to as a “sample surface 8” (which will also be referred to as a “subject surface 8”). The digital holographic imaging apparatus 2 outputs a subject image S1 that represents the phase distribution ϕ_{OBJ}(x, y) of the specimen 4.

The digital holographic imaging apparatus 2 includes an illumination unit 10, an image sensor 20, a reconstruction calculation unit 30, and a display apparatus 40. The digital holographic imaging apparatus 2 can substantially be configured as a lens-free optical system. However, the digital holographic imaging apparatus 2 may include an unshown optical system as necessary.

The illumination unit 10 emits coherent illumination light 12 to the specimen 4. The configuration of the illumination unit 10 is not restricted in particular. The illumination unit 10 may be configured as a semiconductor laser or an LED. The illumination light 12 may be generated as plane-wave light or spherical-wave light. FIG. 2 shows an example in which the illumination light 12 is generated as plane-wave light. In the drawings, the light beams are each represented by a solid line, and the wave fronts are each represented by a dotted line.

The image sensor 20 is configured as a CCD (Charge Coupled Device), a CMOS (Complementary Metal Oxide Semiconductor) sensor, or the like. The image sensor 20 includes multiple pixels arranged on the imaging surface 22 in a two-dimensional manner. The image sensor 20 captures an image of the intensity distribution I(x, y) of the interference pattern generated by the illumination light 14 that has interacted with the specimen 4 or an AF mark 9 described later, and generates captured image data S2. Imaging by means of the image sensor 20 is none other than spatial sampling. The captured image data S2 output from the image sensor 20 is supplied to the reconstruction calculation unit 30, and is supplied to an AF operation unit 80 for an AF operation described later.

After the completion of the AF operation described later, the reconstruction calculation unit 30 reconstructs the subject image S1 that represents the specimen 4 by calculation based on the captured image data S2. It should be noted that the reconstruction calculation unit 30 and the AF operation unit 80 described later may each be configured as a combination of a general-purpose computer and a software program, or may be configured as a dedicated hardware component. A phase retrieval method (Fourier iterative method) can be employed to reconstruct the subject image S1, for example.

The display apparatus 40 displays the subject image S1 generated by the reconstruction calculation unit 30. Furthermore, the display apparatus 40 has a function as a user interface of the digital holographic imaging apparatus 2.

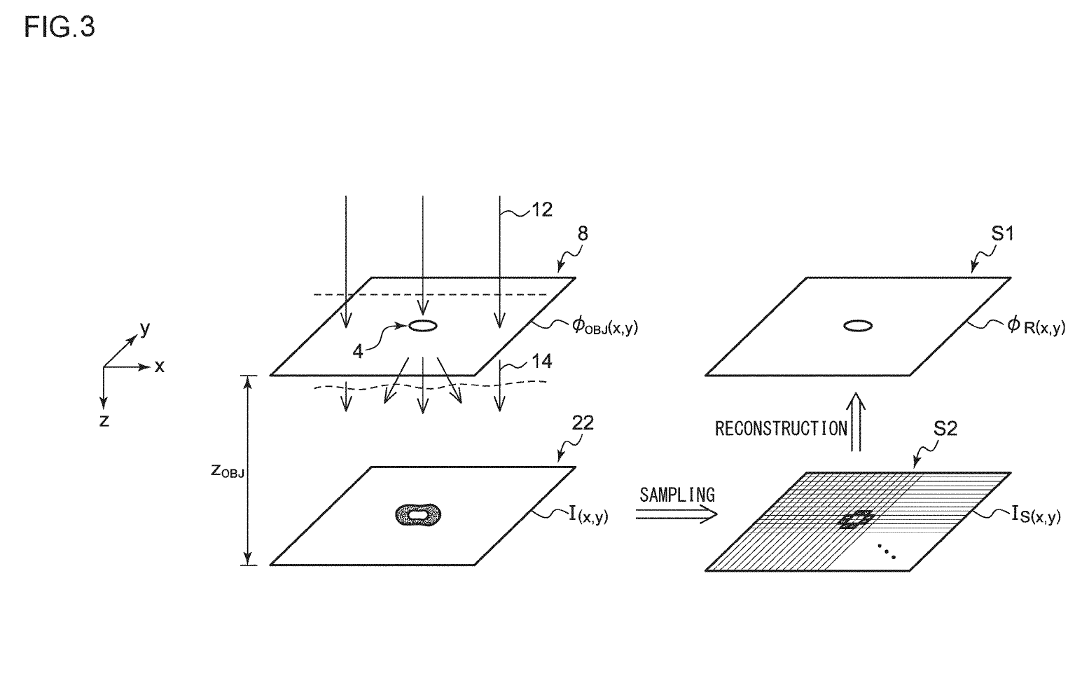

FIG. 3 is a diagram for explaining the principle of the digital holographic imaging apparatus 2. The specimen 4 which is a phase object has a phase distribution ϕ_{OBJ}(x, y) defined in a first direction (x direction) and a second direction (y direction) that is orthogonal to the first direction on the sample surface 8. The phase distribution ϕ_{OBJ}(x, y) corresponds to the shape, structure, composition, or the like, of the specimen 4. The phase distribution ϕ_{OBJ}(x, y) is to be observed by means of the digital holographic imaging apparatus 2. The illumination light 14 that passes through the specimen 4 undergoes phase shifting corresponding to the phase distribution ϕ_{OBJ}(x, y), and the wave fronts thereof are disturbed by the specimen 4. The illumination light 14 that has passed through the specimen 4 includes light that has not been disturbed (diffracted) by the specimen 4 and light diffracted by the specimen 4. These lights propagate at a distance Z_{obj} in the z direction, and generate an interference pattern on the imaging surface (photoelectric conversion face) 22 of the image sensor 20.

The illumination light 14 reaches the imaging surface 22 after it passes through the sample holder 6. The distance Z_{OBJ} represents the optical path length calculated giving consideration to the refractive index of the sample holder 6. Accordingly, it should be noted that the distance Z_{OBJ} does not necessarily match the physical distance between the sample surface 8 and the imaging surface 22. The same can be said of a virtual distance z described later.

The image sensor 20 generates the captured image data S2 that represents the light intensity distribution I(x, y) of an interference pattern. The reconstruction calculation unit 30 reproduces the subject image S1 that represents the phase distribution ϕ_{R}(x, y) by calculation based on the intensity distribution I(x, y) represented by the captured image data S2. The phase distribution ϕ_{R}(x, y) thus reconstructed corresponds to the phase distribution ϕ_{OBJ}(x, y) of the specimen 4.

The above is the basic configuration of the digital holographic imaging apparatus 2. Next, description will be made regarding the characteristics relating to the autofocus operation supported by the digital holographic imaging apparatus 2.

In the present embodiment, an AF mark (which will also be referred to as the “measurement of distance pattern”) 9 is formed in the sample holder 6. Furthermore, the digital holographic imaging apparatus 2 is provided with an AF operation unit 80. The “autofocus operation” supported by the digital holographic imaging apparatus 2 means the operation in which the actual distance between the specimen 4 and the image sensor 20, i.e., the actual distance between the sample holder 6 and the imaging surface 22 (which will be referred to as the “actual distance Z_{OBJ}” hereafter), matches the distance to be used in the reconstruction calculation (which will be referred to as the “virtual distance z” or simply as the “distance z”).

The AF mark 9 changes at least one from among the amplitude and the phase of a part of the illumination light 12. As described later, the AF mark 9 may be formed on the surface of the sample holder 6 on the specimen 4 side, i.e., on the sample surface 8. Also, the AF mark 9 may be formed within the sample holder 6.

The AF operation unit 80 generates, based on the captured image data S2, a first intensity distribution I_{AF}_{_}_{MEAS}(x, y) which is a measurement value of the interference pattern that corresponds to the AF mark 9. Furthermore, the AF operation unit 80 calculates a second intensity distribution I_{AF}_{_}_{CALC}(x, y) which is a calculated value of the interference pattern that corresponds to the AF mark 9. Subsequently, the autofocus operation is performed such that the first intensity distribution I_{AF}_{_}_{MEAS}(x, y) approaches the second intensity distribution I_{AF}_{_}_{CALC}(x, y).

In the autofocus operation, (i) the virtual distance z may be changed while the actual distance Z_{OBJ} is fixed. Also, (ii) the actual distance Z_{OBJ} may be changed while the virtual distance z is fixed. Also, (iii) both the actual distance Z_{OBJ} and the virtual distance z may be changed. In a case of employing the autofocus operation (ii) or (iii), such an arrangement requires a movable mechanism for adjusting the distance between the image sensor 20 and the sample holder 6. In contrast, in a case of employing the autofocus operation (i), this arrangement does not require such a movable mechanism, thereby providing an advantage of allowing the digital holographic imaging apparatus 2 to be designed in a simple manner. Description will be made regarding an arrangement in which the virtual distance z is changed while the actual distance Z_{OBJ} is fixed.

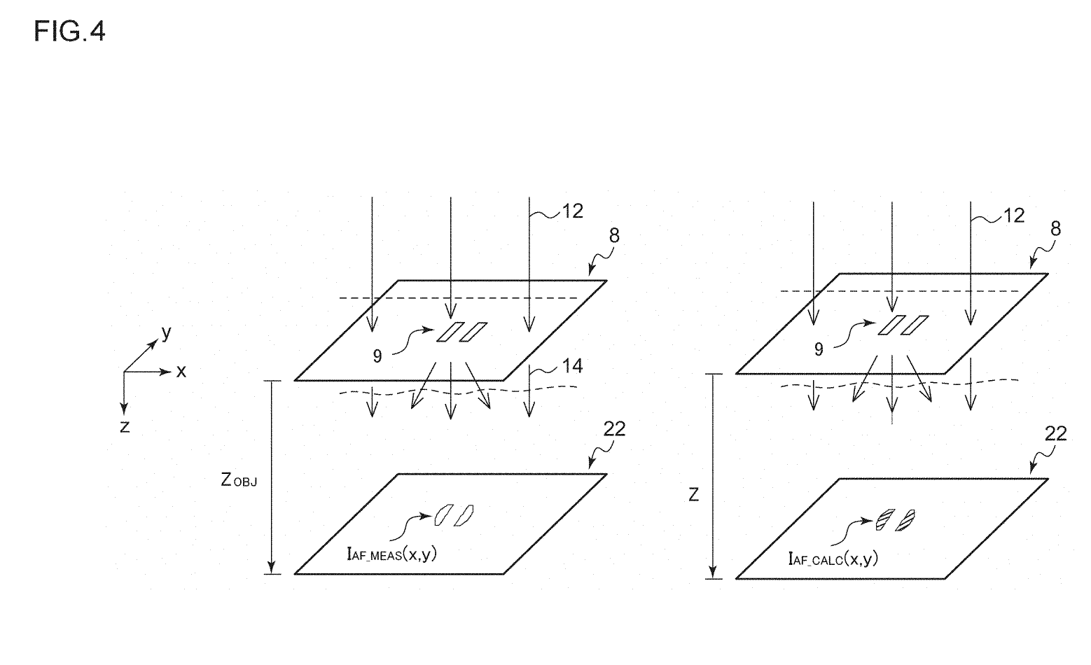

The above is the configuration of the digital holographic imaging apparatus 2. Next, description will be made regarding the AF operation. FIG. 4 is a diagram for explaining the autofocus operation of the digital holographic imaging apparatus 2. As described later, this arrangement is capable of providing the autofocus operation in a state in which the specimen 4 is held by the sample holder 6. For ease of understanding, description will be made regarding a state in which the specimen 4 is omitted.

The AF mark 9 is configured as a known subject. Accordingly, the intensity distribution (second intensity distribution I_{AF}_{_}_{CALC}(x, y)) formed on the imaging surface 22 at a given virtual distance z from the AF mark 9 can be calculated. As the propagation calculation, various kinds of methods such as the Fresnel diffraction integral, angular spectrum method, or the like may be employed. The second intensity distribution I_{AF}_{_}_{CALC}(x, y) changes according to a change in the virtual distance z.

The second intensity distribution I_{AF}_{_}_{CALC}(x, y) thus calculated is compared with the first intensity distribution I_{AF}_{_}_{MEAS}(x, y) captured in actuality. The virtual distance z is adjusted such that the second intensity distribution I_{AF}_{_}_{CALC}(x, y) matches the first intensity distribution I_{AF}_{_}_{MEAS}(x, y), i.e., such that the difference between them becomes sufficiently small. The method for optimizing the virtual distance z is not restricted in particular. Rather, various kinds of known algorithms such as the hill-climbing method, Newton method, quasi Newton method, conjugate gradient method, or the like can be employed.

The above is the autofocus operation of the digital holographic imaging apparatus 2. The digital holographic imaging apparatus 2 provides the autofocus operation without depending on the shape, structure, composition, or the like, of the specimen 4.

Furthermore, in the autofocus operation, this arrangement does not require the image of the specimen 4 to be reconstructed every time the distance z is changed. This arrangement allows the amount of calculation to be dramatically reduced as compared with conventional techniques. This allows the time required for the autofocus operation to be reduced.

The present invention encompasses various kinds of apparatuses, systems, and methods that can be derived from the aforementioned description. That is to say, the present invention is not restricted to a specific configuration. More specific description will be made below regarding example configurations and embodiments for clarification and ease of understanding of the essence of the present invention and the operation. That is to say, the following description will by no means be intended to restrict the technical scope of the present invention.

### First Embodiment

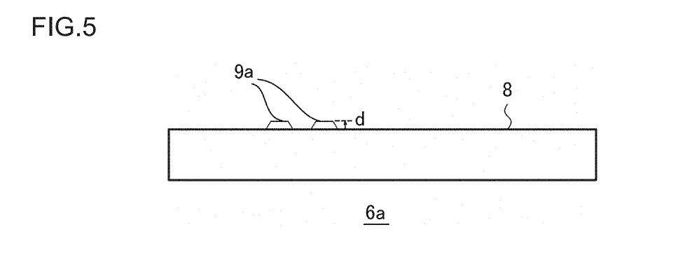

FIG. 5 is a cross-sectional diagram showing a sample holder 6a according to a first embodiment. In the first embodiment, an AF mark 9a is formed on the sample surface 8 of the sample holder 6a. The AF mark 9a changes only the amplitude of the illumination light 12. The AF mark 9a provides the amplitude distribution A_{AF}(x, y). The AF mark 9a can be formed by deposition of a material that absorbs (or reflects) light, such as an aluminum material or chromium material on the sample surface 8 of the sample holder 6a by evaporation or sputtering.

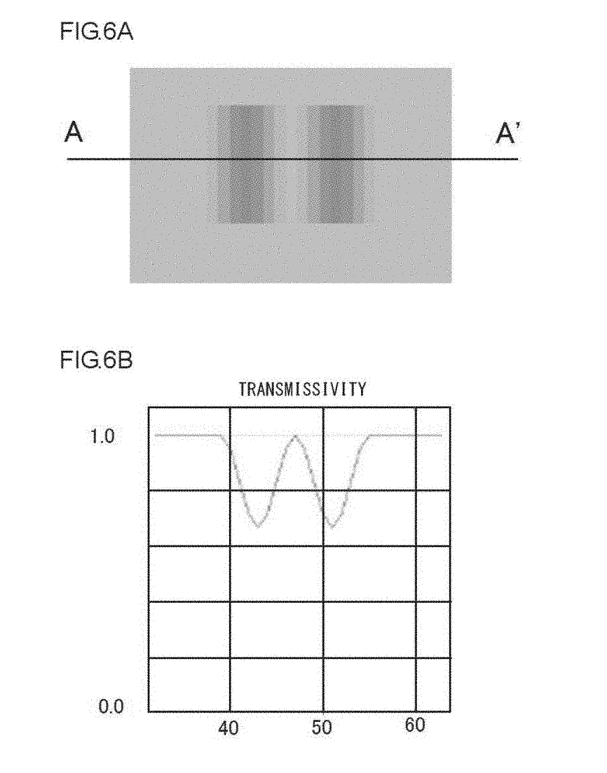

FIGS. 6A and 6B are diagrams for explaining the AF mark 9a according to the first embodiment. FIG. 6A shows the amplitude distribution A_{AF}(x, y) of the AF mark 9a. FIG. 6B shows the transmissivity of the AF mark 9a taken along the line A-A′ shown in FIG. 6A. The transmissivity can be controlled according to the thickness d of the material shown in FIG. 5.

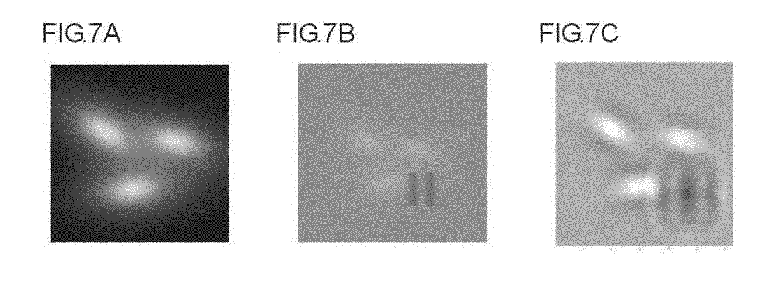

FIG. 7A is a diagram showing the phase distribution ϕ_{OBJ}(x, y) of the specimen 4. FIG. 7B is a diagram showing the position relation between the specimen 4 and the AF mark 9a. FIG. 7C shows a diagram showing the light intensity distribution I(x, y) formed on the imaging surface 22 due to the specimen 4 and the AF mark 9a.

In a case in which the AF mark 9a is positioned in a central region of the specimen 4, this leads to a situation in which a holographic image of the AF mark 9a (interference pattern that corresponds to the AF mark 9a) overlaps the holographic image of the specimen 4a. This leads to difficulty in extracting the first intensity distribution I_{AF}_{_}_{MEAS}(x, y) from the captured image data S2, resulting in a problem in that the autofocus operation cannot be provided with sufficient precision.

In contrast, in a case in which the AF mark 9a is arranged as a completely separate unit from the specimen 4, and in a case in which there is a large distance between the AF mark 9a and the specimen 4, if warping occurs in the sample holder 6a or if the sample holder 6 and the imaging surface 22 are not in parallel with each other, this leads to a problem in that the distance between the AF mark 9a and the imaging surface 22 does not match the distance between the specimen 4 and the imaging surface 22. Accordingly, in this case, such an arrangement is not capable of reconstructing the image of the specimen 4 with high precision even if the distance between the AF mark 9a and the imaging surface 22 can be detected with high precision in the autofocus operation.

In order to solve such problems, the AF mark 9a is preferably formed at a position slightly offset from the central region of the specimen 4, e.g., in a peripheral region of an area in which the specimen 4 is to be arranged.

Next, description will be made regarding the autofocus operation employed in the first embodiment. As described above, the virtual distance z, which is to be used to calculate the second intensity distribution I_{AF}_{_}_{CALC}(x, y), is changed while the actual distance Z_{OBJ} between the sample holder 6a and the imaging surface 22 is fixed.

The autofocus operation unit 80 extracts, from the captured image data S2, the first intensity distribution I_{AF}_{_}_{MEAS}(x, y) which is a measurement value of the interference pattern that corresponds to the AF mark 9a. Subsequently, the following steps are repeated.

(i) The second intensity distribution I_{AF}_{_}_{CALC}(x, y) is calculated by diffraction calculation such that the AF mark 9a propagates at a distance z.

(ii) An index D is calculated such that it represents the difference (or otherwise similarity index) between the first intensity distribution I_{AF}_{_}_{MEAS}(x, y) and the second intensity distribution I_{AF}_{_}_{CALC}(x, y).

(iii) The distance z is adjusted such that the index D becomes its minimum (or otherwise its maximum).

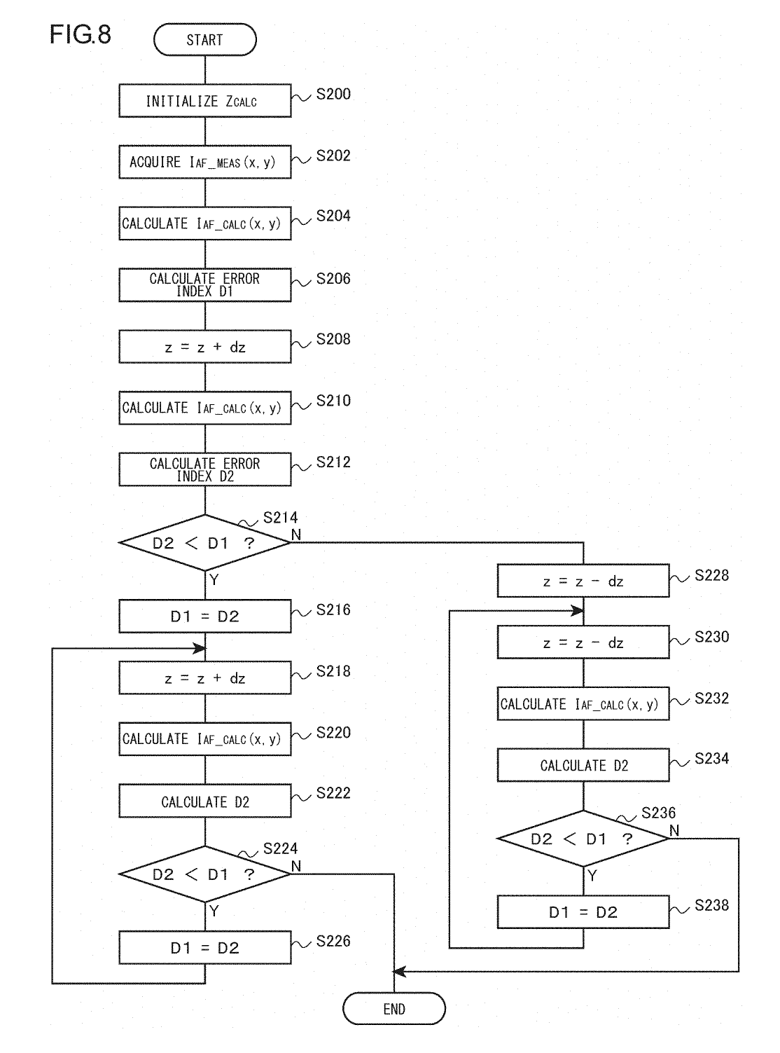

FIG. 8 is a flowchart showing the autofocus operation according to the first embodiment. In the flowchart, the order of steps may be exchanged as desired as long as it does not impede the processing. In this flowchart, the hill-climbing method is employed.

First, the virtual distance z is initialized (S200). As the initial value, the setting value for the actual distance Z_{OBJ} may be employed. Subsequently, the first intensity distribution I_{AF}_{_}_{MEAS}(x, y), which is a measurement value of the interference pattern that corresponds to the AF mark 9a, is extracted from the captured image data S2 (S202). Subsequently, the second intensity distribution I_{AF}_{_}_{CALC}(x, y) is calculated by diffraction calculation such that the AF mark 9a propagates at a virtual distance z (S204). In the diffraction calculation, the Fresnel diffraction integral Expression (1) may be employed. Here, “f(x, y)” represents the complex amplitude of light obtained such that light having a complex amplitude g(x′, y′) has propagated at a distance z in the z-axis direction.

$$\begin{matrix} ( Expression 2 ) & \\ f ( x , y ) = ( \frac{1}{i \cdot λ \cdot z} ) \int g ( {x}^{′} , {y}^{′} ) exp ( \frac{i 2 π}{λ} ( z + \frac{{( {x}^{′} - x )}^{2} + {( {y}^{′} - y )}^{2}}{2 \cdot z} ) ) {dx}^{′} {dy}^{′} & ( 1 )\end{matrix}$$

Subsequently, the index D is calculated, and the calculated index D is held as D1 (S206). As the index D, the sum of the squares of the differences between the first intensity distribution I_{AF}_{_}_{MEAS}(x, y) and the second intensity distribution I_{AF}_{_}_{CALC}(x, y) for each pixel may be employed.

D=ΣₓΣ_{y}(I_{AF}_{_}_{MEAS}(x,y)−I_{AF}_{_}_{CALC}(x,y))² (2)

The index D defined by the Expression (2) represents the difference (error) between the two intensity distributions I_{AF}_{_}_{MEAS} (x, y) and I_{AF}_{_}_{CALC} (x, y). Accordingly, it can be said that, as the index D becomes smaller, the virtual distance z becomes closer to the correct value Z_{OBJ}.

Subsequently, the virtual distance z is increased by a predetermined width dz (S208), and I_{AF}_{_}_{CALC}(x, y) is calculated using the distance z thus updated (S210). The index D in this stage is calculated, and is held as D2 (S212).

Subsequently, the previous index D value, i.e., D1, is compared with the current index D value, i.e., D2 (S214). When D2<D1 holds true (YES in S214), i.e., when the difference becomes smaller, judgement is made that the direction in which z is changed is correct. In this case, D2 is substituted for D1 (S216). Subsequently, the virtual distance z is further raised by the predetermined width dz (S218), and I_{AF}_{_}_{CALC}(x, y) is calculated using the updated distance z (S220). The index D in this stage is calculated, and is held as D2 (S222). When D2<D1 holds true (YES in S224), i.e., when the difference becomes smaller, D2 is substituted for D1 (S226), following which the flow returns to Step S218. When D2≥D1 holds true in Step S224 (NO in S224), the operation ends.

When D2≥D1 holds true in Step S214 (NO in S214), i.e., when the difference becomes larger, the direction in which z is changed is reversed, and z is reduced by the predetermined width dz, i.e., z is restored to the initial value (S228). Furthermore, z is further reduced by the predetermined width dz (S230), and I_{AF}_{_}_{CALC}(x, y) is calculated using the updated distance z (S232). The index D in this stage is calculated, and is held as D2 (S234). When D2<D1 holds true (YES in S236), i.e., when the difference becomes smaller, D2 is substituted for D1 (S238), following which the flow returns to Step S230. When D2≥D1 holds true (NO in S236), the operation ends. The distance z in the end stage of the operation represents the actual distance Z_{OBJ}.

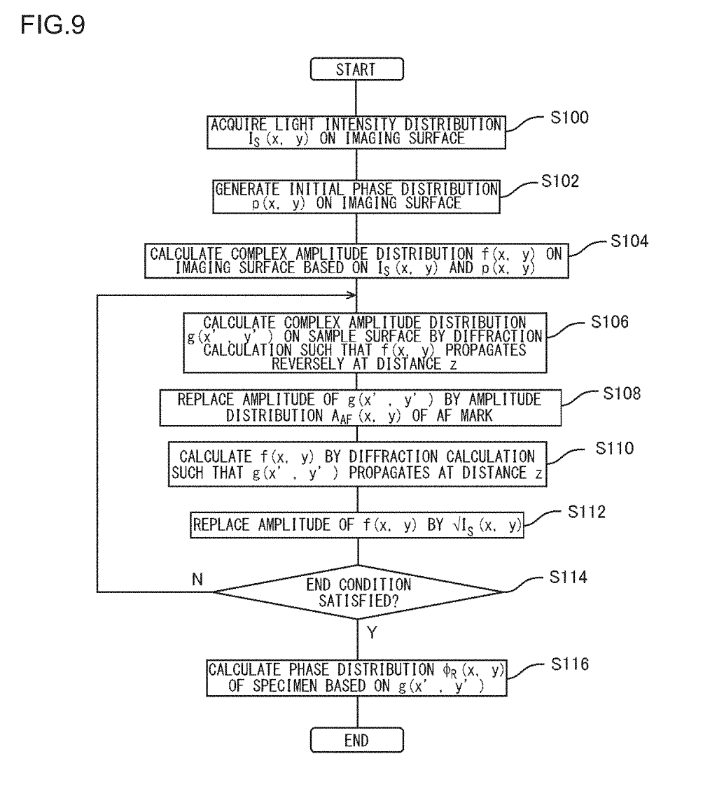

The above is the autofocus operation according to the first embodiment. Next, description will be made regarding the reconstruction calculation after the autofocus operation. FIG. 9 is a flowchart showing the reconstruction calculation for the image of the specimen 4 according to a first embodiment. The captured image data S2 acquired by the image sensor 20 represents the light intensity distribution I_{S}(x, y) formed on the imaging surface 22. The light intensity distribution I_{S}(x, y) includes the light amplitude information √I(x, y), but includes no light phase information. The reconstruction processing is none other than restoring the missing phase information so as to reproduce the phase distribution ϕ_{OBJ}(x, y) on the sample surface 8.

The reconstruction calculation unit 30 acquires the captured image data S2 that represents the light intensity distribution I_{S}(x, y) on the imaging surface 22 (S100). The light intensity distribution I_{S}(x, y) includes an interference pattern that corresponds to the AF mark 9a and an interference pattern that corresponds to the specimen 4. Subsequently, an initial value is set for the phase distribution p(x, y) on the imaging surface 22 (S102). The initial value of the phase distribution p(x, y) may be set to a random value. The complex amplitude distribution f(x, y) on the imaging surface 22 in this stage is calculated based on the Expression (3) (S104).

$$\begin{matrix}( Expression 3 ) & \\ f ( x , y ) = \sqrt{{I}_{s} ( x , y )} exp ( i \frac{2 π}{λ} p ( x , y ) ) & ( 3 )\end{matrix}$$

Subsequently, the complex amplitude distribution g(x′, y′) formed on the sample surface 8 is calculated by diffraction calculation such that the complex amplitude distribution f(x, y) formed on the imaging surface 22 propagates at a distance z reversely in the z-axis direction (S106). As the propagation calculation in this step, the Fresnel diffraction integral Expression (4) may be employed.

$$\begin{matrix} ( Expression 4 ) & \\ g ( {x}^{′} , {y}^{′} ) = ( \frac{1}{i λ ( - z )} ) \int f ( x , y ) exp ( \frac{i 2 π}{λ} ( - z + \frac{{( x - {x}^{′} )}^{2} + {( y - {y}^{′} )}^{2}}{2 \cdot ( - z )} ) ) dxdy & ( 4 )\end{matrix}$$

Subsequently, the complex amplitude distribution g(x′, y′) on the sample surface 8 is amended and updated based on a constraint condition for the sample surface 8 (S108). Specifically, the specimen 4 is a phase object, and accordingly, the specimen 4 has no effect on the amplitude distribution. Accordingly, the amplitude component of the complex amplitude distribution g(x′, y′) on the sample surface 8 can be replaced by the amplitude distribution A_{AF}(x, y) of the AF mark 9a.

$$\begin{matrix}( Expression 5 ) & \\ g ( {x}^{′} , {y}^{′} ) ← {A}_{AF} ( {x}^{′} , {y}^{′} ) exp ( i \frac{2 π}{λ} arg ( g ( {x}^{′} , {y}^{′} ) ) ) & ( 5 )\end{matrix}$$

Here, “arg( )” represents the phase component of a complex number.

Subsequently, the complex amplitude distribution f(x, y) on the imaging surface 22 is calculated by diffraction calculation such that the complex amplitude distribution g(x′, y′) obtained in Step S108 propagates at a distance z in the z-axis direction (S110). As the propagation calculation in this step, the Fresnel diffraction integral Expression (1) may also be employed.

The complex amplitude distribution f(x, y) is amended and updated using the light intensity distribution I_{S}(x, y) of the captured image data S2 (S112). Specifically, according to the following Expression (6), the amplitude distribution of the complex amplitude distribution f(x, y) is replaced by the amplitude distribution √I_{S}(x, y) calculated based on the intensity distribution I_{S}(x, y) that represents a measured amplitude distribution while maintaining the phase distribution thereof.

$$\begin{matrix}( Expression 6 ) & \\ f ( x , y ) ← \sqrt{{I}_{S} ( x , y )} exp ( i \frac{2 π}{λ} arg ( f ( x , y ) ) ) & ( 6 )\end{matrix}$$

Subsequently, judgment is made regarding whether or not a predetermined end condition has been satisfied (S114). The end condition is not restricted in particular. For example, when the number of iterations reaches a predetermined number, judgement may be made that the end condition has been satisfied. Also, when the amplitude distribution of the complex amplitude distribution g(x′, y′) obtained in Step S106 has sufficient uniformity, judgement may be made that the end condition has been satisfied. When the end condition has not been satisfied (NO in S114), the flow returns to Step S106.

When the end condition has been satisfied in Step S114 (YES in S114), the phase distribution ϕ_{R}(x, y) of the specimen 4 is calculated based on the complex amplitude distribution g(x′, y′) according to the following Expression (7) (S116). The phase distribution ϕ_{R}(x, y) represents the subject image S1 to be acquired.

ϕ_{R}(x,y)=arg(g(x′,y′)) (7)

### Second Embodiment

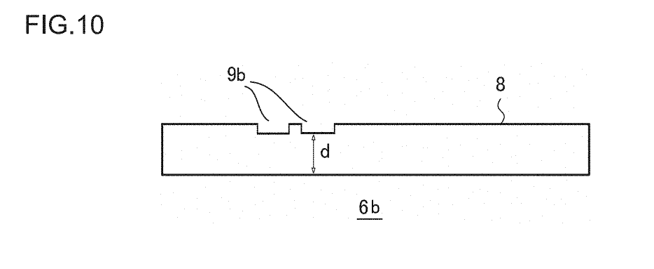

FIG. 10 is a cross-sectional diagram showing a sample holder 6b according to a second embodiment. In the second embodiment, an AF mark 9b is formed in the sample surface of the sample holder 6a, and only the phase of the illumination light 12 is changed. The AF mark 9b has the phase distribution ϕ_{AF}(x, y).

The phase distribution ϕ_{AF}(x, y) of the AF mark 9b can be controlled according to the thickness d of the sample holder 6b. Accordingly, in a step in which the sample holder 6b is manufactured, the AF mark 9b can also be formed at the same time, which is an advantage. Specifically, a recess or a protrusion may preferably be formed based on the effective thickness of the sample holder 6b calculated giving consideration to the refractive index of the sample holder 6b.

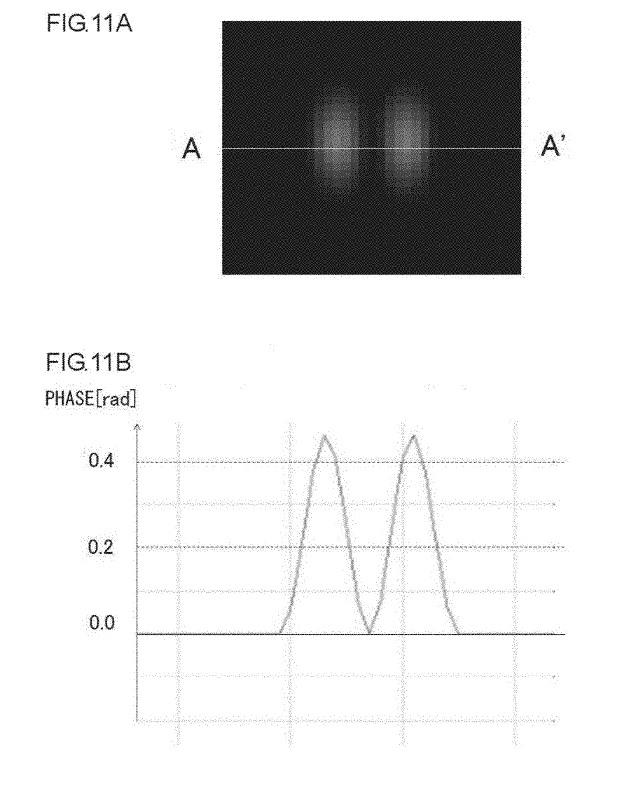

FIGS. 11A and 11B are diagrams for explaining the AF mark 9b according to the second embodiment. FIG. 11A shows the phase distribution ϕ_{AF}(x, y) of the AF mark 9b. FIG. 11B shows the phase taken along the line A-A′ in FIG. 11A.

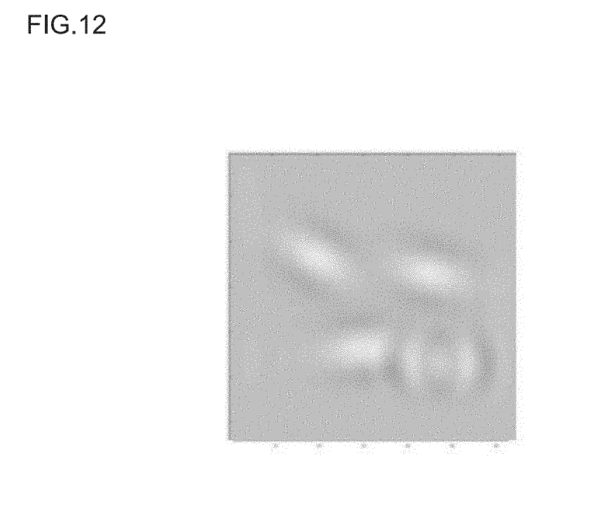

FIG. 12 is a diagram showing the light intensity distribution I(x, y) formed on the imaging surface 22 due to the specimen 4 and the AF mark 9b. The specimen 4 and the AF mark 9b can each be regarded as a phase object that provides a constant amplitude distribution. However, as a result of the propagation of the images thereof at a distance z, an intensity distribution is formed on the imaging surface 22 corresponding to an interference pattern between them.

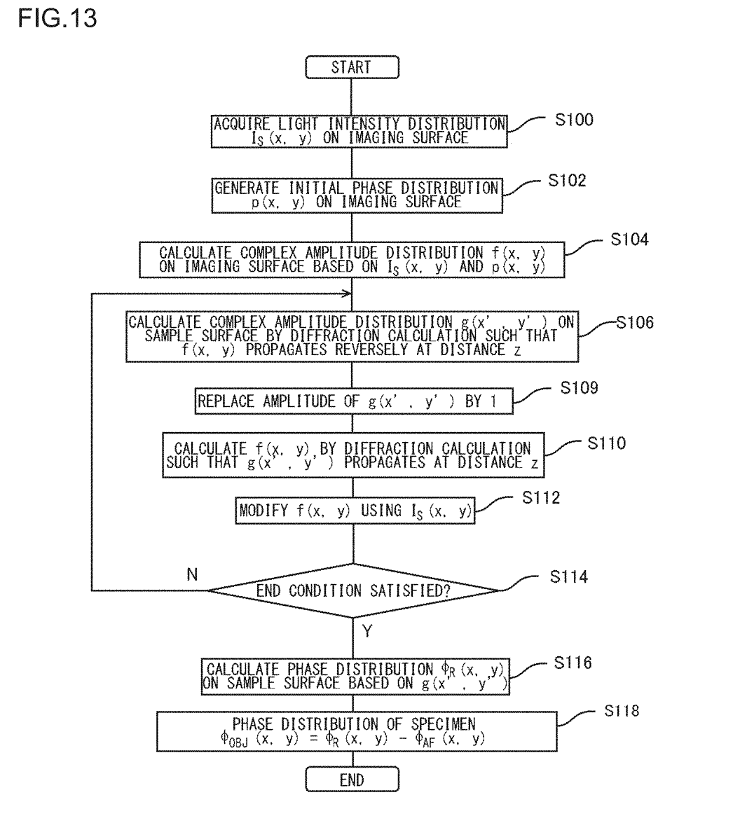

The autofocus operation in the second embodiment is the same as that in the first embodiment. Next, description will be made regarding the reconstruction calculation after the autofocus operation. FIG. 13 is a flowchart showing a reconstruction calculation for an image of the specimen 4 according to the second embodiment. Description will be made regarding only the point of difference from that shown in FIG. 9. In the flowchart shown in FIG. 13, a step S109 is executed instead of the step S108 shown in FIG. 9. With the second embodiment, the specimen 4 and the AF mark 9b are each configured as a phase object, and accordingly, they have no effect on the amplitude distribution. Accordingly, the amplitude component of the complex amplitude distribution g(x′, y′) on the sample surface 8 can be replaced by 1 over the entire area.

Furthermore, in the flowchart shown in FIG. 13, a step S118 is provided after the step S116 shown in FIG. 9. With the second embodiment, the phase distribution ϕ_{R}(x, y) on the sample surface 8 acquired in Step 116 includes the phase distribution ϕ_{AF}(x, y) of the AF mark 9b in addition to the phase distribution ϕ_{OBJ}(x, y) of the specimen 4. Accordingly, by subtracting the phase distribution ϕ_{AF}(x, y) of the AF mark 9b from the phase distribution ϕ_{R}(x, y), this arrangement is capable of acquiring the phase distribution ϕ_{OBJ}(x, y) of the specimen 4.

### Third Embodiment

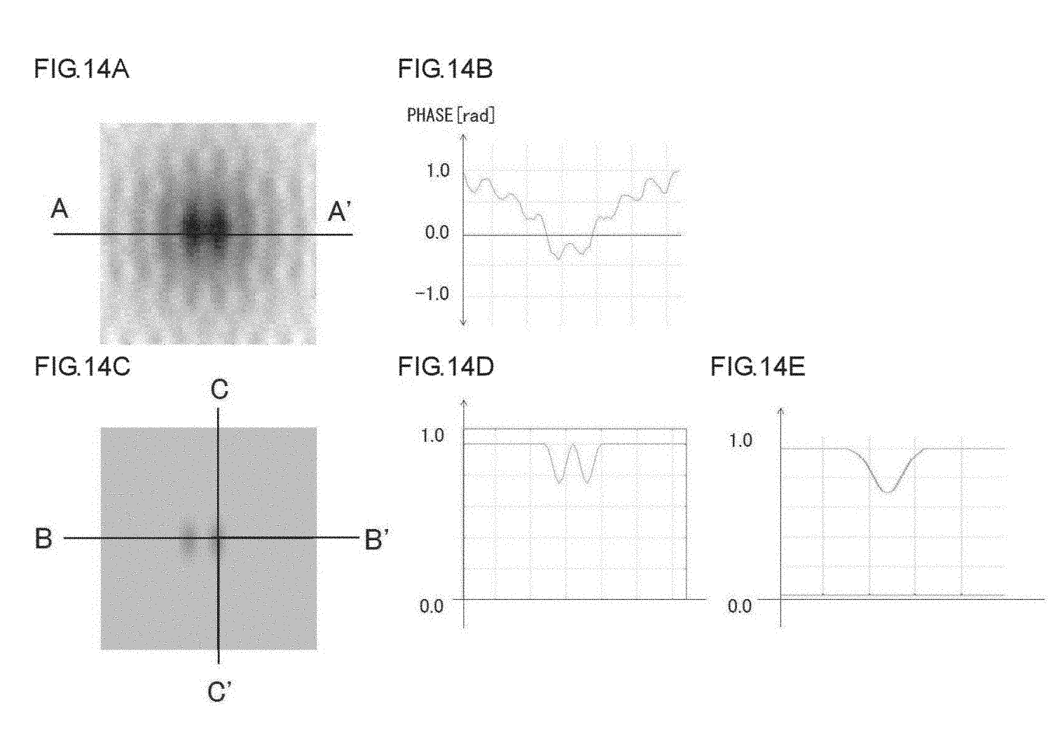

FIGS. 14A through 14E are diagrams for explaining an AF mark 9c according to a third embodiment. FIG. 14A shows a phase distribution ϕ_{AF}(x, y) of the AF mark 9c. FIG. 14B shows a phase distribution taken along the line A-A′ in FIG. 14A. FIG. 14C shows an intensity distribution of an interference pattern formed on the imaging surface 22 corresponding to the AF mark 9c, and FIG. 14D shows an intensity distribution taken along the line B-B′ in FIG. 14C. FIG. 14E shows an intensity distribution taken along the line C-C′ in FIG. 14C.

In the third embodiment, in order to provide further improved autofocus precision, the AF mark 9c is designed so as to form an interference pattern on the imaging surface 22 such that it is positioned outside of a region that receives zero-order light emitted from the specimen 4. That is to say, the interference pattern due to the AF mark 9c and the interference pattern due to the specimen 4 do not overlap on the imaging surface 22. The AF mark 9c is designed to form a localized interference pattern on the imaging surface 22. In contrast, the AF mark 9c provided to the sample surface 8 is formed over the entire region of the sample holder 6c.

### Design of AF Mark 9

The AF mark 9c, which is capable of forming an interference pattern on the imaging surface 22, may be structured to provide only a phase distribution ϕ_{AF}(x, y), only an amplitude distribution A_{AF}(x, y), or a combination thereof. An AF mark that supports such a combination of the phase distribution ϕ_{AF}(x, y) and the intensity distribution A_{AF}(x, y) requires strict position matching between the two distributions, leading to difficulty in manufacturing. Accordingly, the AF mark 9 is preferably designed to provide only the phase distribution ϕ_{AF}(x, y).

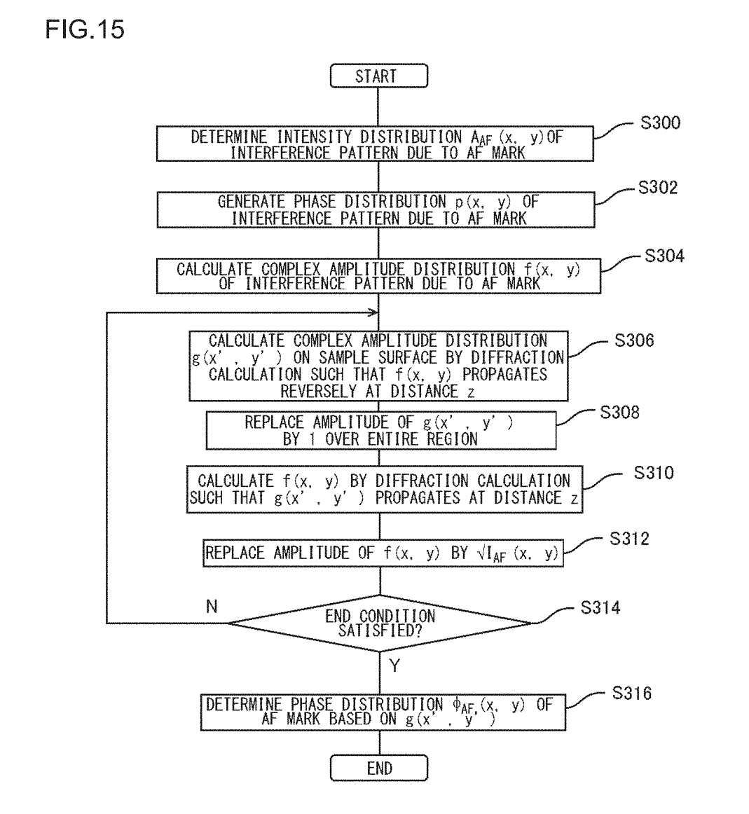

FIG. 15 is a flowchart showing a design method for the AF mark 9c that provides such a phase distribution. First, the intensity distribution I_{AF}(x, y) of an interference pattern that corresponds to the AF mark 9c is defined (S300). Subsequently, a phase distribution p(x, y) is generated as a random distribution (S302). The initial value of the complex amplitude distribution f(x, y) on the imaging surface 22 is calculated according to the following Expression (8) (S304).

$$\begin{matrix}( Expression 7 ) & \\ f ( x , y ) = \sqrt{{I}_{AF} ( x , y )} exp ( i \frac{2 π}{λ} p ( x , y ) ) & ( 8 )\end{matrix}$$

Next, the complex amplitude distribution g(x′ y′) formed on the sample surface 8 is calculated by diffraction calculation such that the complex amplitude distribution f(x, y) on the imaging surface 22 propagates at a distance z in the reverse direction, i.e., toward the negative side in the z-axis direction (S306). As the propagation calculation in this step, the Fresnel diffraction integral may also be employed.

The AF mark 9c is configured as a phase object that has no effect on the amplitude distribution. Accordingly, the amplitude component of the complex amplitude distribution g(x′, y′) on the sample surface 8 is replaced by 1 over the entire region (S308).

Next, the complex amplitude distribution f(x, y) on the imaging surface 22 is calculated by diffraction calculation such that the complex amplitude distribution g(x′, y′) obtained in Step S308 propagates at a distance z in the z-axis direction (S310).

The complex amplitude distribution f(x, y) is amended and updated using the defined interference pattern I_{AF}(x, y) (S312). Specifically, according to the following Expression (9), the amplitude distribution of the complex amplitude distribution f(x, y) is replaced by the amplitude distribution √I_{AF}(x, y) derived from the intensity distribution I_{AF}(x, y) while maintaining the phase component of the f(x, y).

$$\begin{matrix}( Expression 8 ) & \\ f ( x , y ) ← \sqrt{{I}_{AF} ( x , y )} exp ( i \frac{2 π}{λ} arg ( f ( x , y ) ) ) & ( 9 )\end{matrix}$$

Next, judgment is made regarding whether or not a predetermined end condition has been satisfied (S314). The end condition is not restricted in particular. For example, when the number of iterations reaches a predetermined number, judgement may be made that the end condition has been satisfied. Also, when the amplitude distribution of the complex amplitude distribution g(x′, y′) obtained in Step S106 has sufficient uniformity, judgement may be made that the end condition has been satisfied. When the end condition has not been satisfied (NO in S314), the flow returns to Step S306.

When the end condition has been satisfied in Step S314 (YES in S314), the phase distribution ϕ_{AF}(x, y) of the AF mark 9c is calculated according to the following Expression (10) using the complex amplitude distribution g(x′, y′) (S316).

ϕ_{AF}(x,y)=arg(g(x′,y′)) (10).

The above is the design method for the AF mark 9c according to the third embodiment.

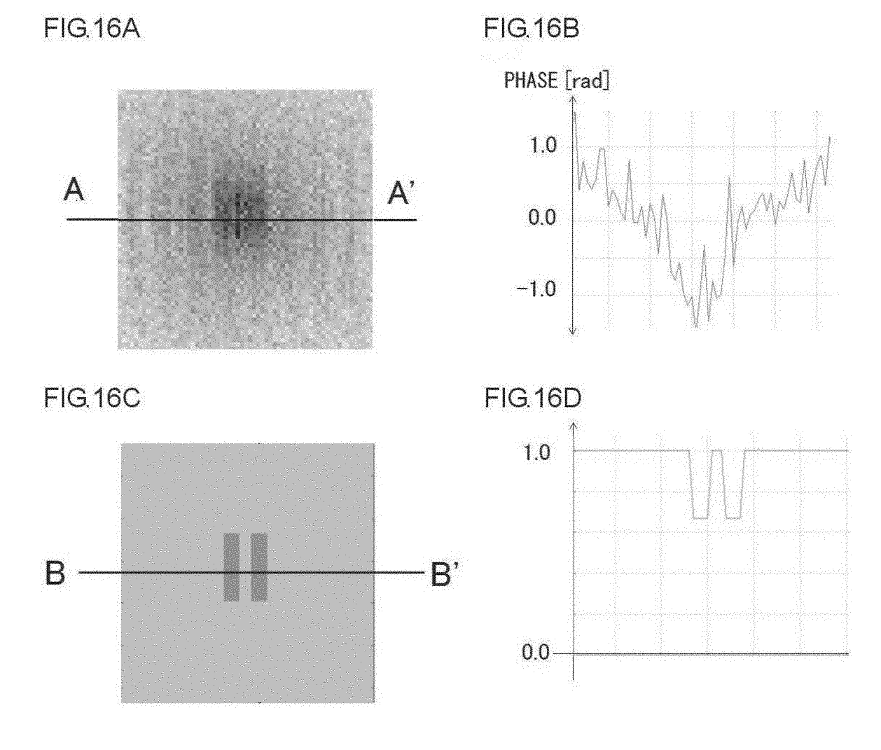

FIGS. 16A through 16D are diagrams for explaining another example of the AF mark 9c. FIG. 16A shows a phase distribution ϕ_{AF}(x, y) of the AF mark 9c. FIG. 16B shows a phase distribution taken along the line A-A′ in FIG. 16A. FIG. 16C shows an intensity distribution of an interference pattern formed on the imaging surface 22 corresponding to the AF mark 9c. FIG. 16D is an intensity distribution taken along the line B-B′ in FIG. 16C.

As shown in FIGS. 16C and 16D, in a case in which, as an interference pattern on the imaging surface 22 that corresponds to the AF mark 9, a high-contrast image, i.e., an image including high spatial frequency components, is to be formed, such an arrangement requires the AF mark 9c to have a complicated phase distribution ϕ_{AF}(x, y), leading to difficulty in the manufacturing of such an AF mark 9c. From this viewpoint, the interference pattern that corresponds to the AF mark 9c is preferably designed such that it does not include such high spatial frequency components. For example, the interference pattern as shown in FIGS. 14C through 14E is configured to have low spatial frequency components as compared with the interference pattern shown in FIGS. 16C and 16D. Accordingly, the AF mark 9c shown in FIGS. 14A and 14B has a simple structure as compared with that shown in FIGS. 16A and 16B, thereby allowing the AF mark 9c to be manufactured in a simple manner.

Description has been made above regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

### First Modification

Description has been made in the embodiment regarding an arrangement in which the specimen 4 is a phase object having a phase distribution. Also, the specimen 4 may be an amplitude object having an intensity distribution. Also, the specimen 4 may be configured to provide both a phase distribution and an intensity distribution. In a case in which the specimen 4 is an amplitude object, a constraint condition in which the phase distribution is constant may be employed in the reconstruction calculation.

Otherwise, a constraint condition in which the phase distribution ϕ_{OBJ}(x, y) and ϕ_{R}(x, y) of the specimen 4 are sparse may be employed in the reconstruction calculation. As an example, a transformation operator ψ is introduced. Here, “ψ” is an operator that transforms a matrix into a sparse matrix. For example, “ψ” may represent discrete cosine transformation (DCT). The fact that an image acquired in nature has a feature of being sparse as described above corresponds to a small primary norm of a matrix transformed by the operator ψ as represented by Expression (11). Here, “∥_{L1}” represents the primary norm.

|ψ{ϕ_{OBJ}(x,y)}|_{L1} (11)

Accordingly, ϕ_{R}(x, y) may be calculated such that it converges to ϕ_{OBJ}(x, y) by iterative calculation under a constraint condition in which the value represented by the Expression (11) is smaller than a predetermined value.

Description has been made in the embodiment regarding an arrangement in which the subject image ϕ_{R}(x, y) is reproduced from single captured image data S2. Also, the subject image ϕ_{R}(x, y) may be reproduced from multiple captured image data S2 measured under different conditions. Also, known algorithms may be employed. For example, multiple captured image data S2 may be acquired with different wavelengths of the illumination light 12. The subject image ϕ_{R}(x, y) may be reconstructed based on the multiple captured image data S2 thus acquired.

### Second Modification

Description has been made regarding the digital holographic imaging apparatus 2 that measures transmitted light that passes through the specimen 4. Also, the digital holographic imaging apparatus 2 may be configured as a type for measuring reflected light. In this case, the AF mark formed in the sample holder 6 may be configured as a reflective mark or otherwise a transmissive mark.

### Third Modification

Description has been made in the embodiment regarding an arrangement in which the AF mark 9 is formed on the sample surface 8 side. Also, the AF mark 9 may be formed on the opposite face.

The digital holographic imaging apparatus and the like according to the present embodiment may include one or more processors and a storage (e.g., a memory). The functions of individual units in the processor(s) may be implemented by respective pieces of hardware or may be implemented by an integrated piece of hardware, for example. The processor may include hardware, and the hardware may include at least one of a circuit for processing digital signals and a circuit for processing analog signals, for example. The processor may include one or a plurality of circuit devices (e.g., an IC) or one or a plurality of circuit elements (e.g., a resistor, a capacitor) on a circuit board, for example. The processor may be a CPU (Central Processing Unit), for example, but this should not be construed in a limiting sense, and various types of processors including a GPU (Graphics Processing Unit) and a DSP (Digital Signal Processor) may be used. The processor may be a hardware circuit with an ASIC (Application Specific Integrated Circuit) or an FPGA (Field-Programmable Gate Array). The processor may include an amplification circuit, a filter circuit, or the like for processing analog signals. The memory may be a semiconductor memory such as an SRAM and a DRAM; a register; a magnetic storage device such as a hard disk device; and an optical storage device such as an optical disk device. The memory stores computer-readable instructions, for example. When the instructions are executed by the processor, the functions of each unit of the image processing device and the like are implemented. The instructions may be a set of instructions constituting a program or an instruction for causing an operation on the hardware circuit of the processor.

The units in the digital holographic imaging apparatus and the like and the display apparatus according to the present embodiment may be connected with each other via any types of digital data communication such as a communication network or via communication media. The communication network may include a LAN (Local Area Network), a WAN (Wide Area Network), and computers and networks which form the internet, for example.

What is claimed is:

1. A digital holographic imaging apparatus comprising:
an illumination unit structured to emit an illumination light to a specimen;
a sample holder structured to hold the specimen, and to have an AF mark structured to change at least one from among an amplitude and a phase of a part of the illumination light;
an image sensor including a plurality of pixels arranged in a two-dimensional manner on an imaging surface, and structured to capture an image of an intensity distribution of an interference pattern formed on the imaging surface, and to output captured image data; and
one or more processor being configured to:
generate a first intensity distribution based on the captured image data, the first intensity distribution representing a measurement value of an interference pattern that corresponds to the AF mark;
calculate a second intensity distribution, the second intensity distribution representing a calculated value of the interference pattern that corresponds to the AF mark;
execute an autofocus operation such that the first intensity distribution approaches the second intensity distribution; and
reconstruct a subject image that represents the subject based on the captured image data.

2. The digital holographic imaging apparatus according to claim 1, wherein the AF mark is formed on a sample surface of the sample holder that is to be in contact with the specimen.

3. The digital holographic imaging apparatus according to claim 1, wherein the AF mark is structured to change only a phase of the illumination light.

4. The digital holographic imaging apparatus according to claim 1, wherein the AF mark is structured to change only an amplitude of the illumination light.

5. The digital holographic imaging apparatus according to claim 1, wherein the AF mark is designed to form an interference pattern on the imaging surface such that it is positioned outside of a region that receives a zero-order light emitted from the specimen.

6. The digital holographic imaging apparatus according to claim 5, wherein a spatial frequency band of the interference pattern that corresponds to the AF mark is limited such that a spatial resolution of the AF mark is larger than a processing limit value for the AF mark.

7. The digital holographic imaging apparatus according to claim 1, wherein the one or more processor is configured to change a distance used in calculation of the first intensity distribution while a distance between the sample holder and the imaging surface is fixed.

8. The digital holographic imaging apparatus according to claim 7, wherein the one or more processor is configured to repeat:
calculating the second intensity distribution such that the AF mark propagates at a distance z;
calculating an index that represents a difference or otherwise a similarity between the first intensity distribution and the second intensity distribution; and
changing the distance z so as to minimize or otherwise maximize the index.

9. The digital holographic imaging apparatus according to claim 8, wherein the index is a sum of squares of differences between the first intensity distribution and the second intensity distribution for each pixel.

10. The digital holographic imaging apparatus according to claim 1, wherein the one or more processor is configured to change a distance between the sample holder and the imaging surface while a distance used in calculation of the second intensity distribution is fixed.

11. A sample holder employed in a digital holographic imaging apparatus, and structured to hold a specimen, wherein the sample holder comprises an AF mark arranged on a sample surface thereof that is to be in contact with the specimen,
wherein the AF mark is structured to change at least one from among an amplitude and a phase of a part of an illumination light.
